(19) United States
(12) Patent Application Publication
(10) Pub. No.: US 2026/0265927 A1
(43) Pub. Date: Sep. 10, 2026

(54) Method of Producing Hydrogen From Water Using Renewable Energy

(71) Applicant: LSG Partners, LLC, Sarasota, FL (US)

(72) Inventor: Robinson Burroughs Gourley, Sarasota, FL (US)

(73) Assignee: LSG Partners, LLC, Sarasota, FL (US)

(21) Appl. No.: 19/069,413

(22) Filed: Mar. 4, 2025

(51) Int. Cl. C25B 1/50; B01D 53/22; B01D 71/02; C25B 1/01; C25B 9/65; C25B 15/08

(52) U.S. Cl. CPC C25B 1/50; B01D 53/228; B01D 71/028; C25B 1/01; C25B 9/65; C25B 15/083; B01D 2256/16; B01D 2257/104

(57) ABSTRACT

A method for producing hydrogen gas (H₂) from dioxytetrahydride gas (H₄O₂). Dioxytetrahydride gas is prepared by forming a reaction media having an aqueous electrochemical solution comprising one or more alkaline salts; placing the reaction media into a receptacle of an apparatus having a power supply and producing a magnetic field in a reaction zone via a direct electric current; collecting the dioxytetrahydride gas formed in the reaction zone after exposure to the magnetic field; infusing the collected dioxytetrahydride gas into a molecular sieve; separating hydrogen atoms from oxygen atoms in the molecular sieve; forming hydrogen gas spontaneously from the hydrogen atoms; and collecting the hydrogen gas from the molecular sieve. Significantly less energy and expense are required to produce hydrogen gas by this method compared to existing methods for producing hydrogen gas.

### CROSS REFERENCE TO RELATED APPLICATIONS

This patent application is a continuation in part of U.S. patent application Ser. No. 17/402,686, currently pending, which is a divisional patent application of U.S. patent application Ser. No. 15/697,623, abandoned, which is a continuation-in-part of U.S. patent application Ser. No. 15/059,337, filed Mar. 3, 2016, abandoned, which is a continuation-in-part application of U.S. patent application Ser. No. 12/596,077, filed Mar. 17, 2010, abandoned, which is a 371 of PCT/US08/60666, filed Apr. 17, 2008, which is a continuation-in-part application of U.S. patent application Ser. No. 11/738,476, filed Apr. 21, 2007, abandoned, from which priority is claimed.

### TECHNICAL FIELD

The method disclosed herein relates to the generation of a purified single stable gas (H₄O₂) from water H₂O, and, more particularly, to a method for producing hydrogen gas (H₂) from said single stable gas (H₄O₂) using sources of clean energy.

### BACKGROUND OF THE DISCLOSURE

The method of producing a single stable gas (H₄O₂) from water, as opposed to a mixture of hydrogen gas and oxygen gas, involves the use of strong electromagnetic fields using iron plates to transfer electrons through water-based electrochemical solutions. This electro-magnetic process binds two oxygen atoms into a diatomic bond with four hydrogen atoms while adding electrons to hydrogen atoms causing both stabilization of the water-gas molecule and repulsion of other water-gas molecules thereby creating a stable gaseous form of water that is dioxytetrahydride (i.e. H₄O₂). Dioxytetrahydride is an electron-rich gaseous form of water not created by electrolysis. The dioxytetrahydride is created when very strong magnetic fields are applied to liquid water mixed in an electrochemical solution. Using an electromagnetic field of the instant invention, oxygen atoms of two water molecules are brought into a diatomic bond. The four hydrogens from the two water molecules pick up added electrons, changing the bond angle between hydrogen and oxygen from 104° to 118° and thus creating a crystal type structure, dioxytetrahydride. The electrons of each water gas molecule repel each other which, in turn, creates a stable gaseous form of water, dioxytetrahydride. This explains how relatively low energy below that used in normal electrolysis can be used to convert liquid water into gaseous water.

Electrolysis of water is known to produce hydrogen gas (H₂) at a cathode and oxygen gas (O₂) at an anode. Due to the high heat of the chambers, water vapor also results from this process. If the hydrogen gas and oxygen gas were not effectively separated, such methods would result in an impure gaseous product that could not be effectively compressed or stored under pressure for industrial applications in a single container and is deemed explosive and dangerous. Thus, it remained desirable to develop a method by which a useful, stable, purified, compressible single gas could be formed from water.

### BRIEF DESCRIPTION OF THE DRAWINGS

FIG. 1 illustrates a schematic of a preferred reaction chamber for the production of dioxytetrahydride gas.

FIG. 2 illustrates a graph (basolateral) showing the absorption of Vitamin C by cells treated with dioxytetrahydride-infused water and control.

FIG. 3 shows the effect of dioxytetrahydride on apical cells.

FIG. 4 illustrates the rate of dioxytetrahydride absorption in water.

FIG. 5 shows a diagram of a system to produce dioxytetrahydride gas and to generate hydrogen gas (H₂) from the dioxytetrahydride gas (H₂O₄).

### SUMMARY OF THE DISCLOSURE

Hydrogen gas (H₂) can be prepared from dioxytetrahydride gas (H₄O₂). Dioxytetrahydride gas is obtained from an electrolyte and water solution (electrochemical solution) capable of conducting an electric current wherein the electrolyte and water solution has a specific gravity ranging from 1.0 to 3.0. The electrolyte and water solution are placed in a receptacle and an anode and a cathode formed of material capable of being magnetized are placed in the electrolyte and water solution in the receptacle. The anode and the cathode are spaced 0.2 to 0.3 inches apart. A direct electrical current to the anode and to the cathode and to the electrolyte and water solution is provided at 1.2 to 1.8 volts at 0.2 to 0.3 amps per square inch of cathode surface area, in the presence of a magnetic field ranging from 16 to 24 Gauss units. The magnetic field generates dioxytetrahydride gas from the water in the electrolyte and water solution. The dioxytetrahydride gas generated from the water in the electrolyte and water solution is collected and is passed through a molecular sieve. Hydrogen atoms and oxygen atoms in the dioxytetrahydride gas are separated from each other in the molecular sieve. Hydrogen atoms pass through the molecular sieve and combine to form molecular hydrogen gas (H₂). The molecular hydrogen gas (H₂) is collected from the molecular sieve.

The collected dioxytetrahydride gas can be passed into the molecular sieve using pressure generated in the receptacle during formation of the dioxytetrahydride gas. The molecular sieve is, preferably, a ceramic membrane substrate. 0.0028 kWh of the DC electric current will produce 0.8-1.3 liters of dioxytetrahydride gas which yields at least 0.08-0.13 liter of hydrogen gas. Producing a magnetic field in the reaction zone can be produced via a DC electric current using a solar and/or wind electricity generator.

An advantage of this method of preparing hydrogen gas is that the hydrogen gas can be obtained easily by molecular filtration of dioxytetrahydride.

Another advantage is the relatively little energy is required to produce dioxytetrahydride gas from water.

Another advantage is the ability to produce hydrogen gas at significantly less expense compared to current methods of producing hydrogen gas.

### DETAILED DESCRIPTION

In a first step of the method of generating the single stable gas, water in the form of an electrochemical solution is provided to a reaction zone in a receptacle. The electrochemical solution is an electrolytic fluid comprising a salt dissolved in distilled water, where the salt is selected from the group consisting of potassium hydroxide, lithium hydroxide and sodium hydroxide and the electrochemical solution has a specific gravity ranging from 1.0 to 1.3. The electrochemical solution is provided to the receptacle which is preferably closed off to allow the reaction to occur under pressure.

The receptacle which can be made out of a variety of materials including sheet steel, stainless steel, CVPVC and epoxy resin fiberglass. The apparatus and internal devices need to be heat resistant and waterproof. Overall, the method employs creation of a magnetic field in which two oxygen atoms of water are forced into a diatomic bond with four hydrogen atoms of water. Under these conditions two water molecules bind in a stable gaseous state and there is no electrolysis occurring and no forming of hydrogen gas or oxygen gas. Under these conditions, a single gas, referred to as dioxytetrahydride (H₄O₂), is generated and collected. Dioxytetrahydride has desirable properties and is useful for various applications.

In a first step of the method, a magnetic field is generated in the reaction zone. Preferably, the magnetic field is applied by providing a source of electric power to said reaction zone. A direct electric current in the reaction zone provides a magnetic field. The magnetic field is about 20 Gauss units, ranging from 16 to 24 gauss units. The direct electric current is, preferably, about 0.25 amps per square inch of cathode surface area, ranging from 0.2 to 0.3 amps per square inch of cathode surface area. The voltage is, preferably, about 1.5 volts, ranging from 1.2 volts to 1.8 volts.

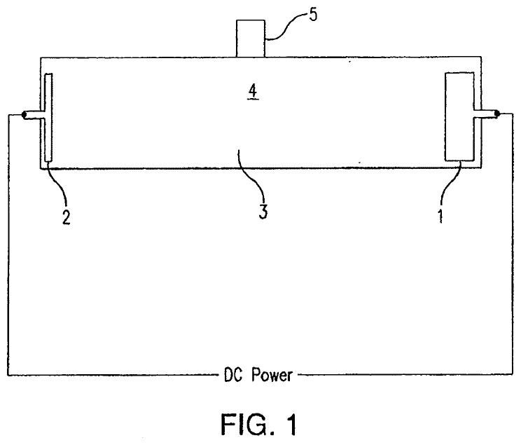

In a preferred embodiment, (see FIG. 1) two iron end plates 1 and 2 having an inside surface and an outside surface and having the capacity to conduct an electrical current are used in the reaction zone 4 in opposing configuration. The inside of each end plate 1 and 2 is submerged in the electrochemical solution 3. The plates 1 and 2 should be separated a sufficient distance so that a magnetic field forms when current is applied to the reaction zone 4 but electrolysis of water into hydrogen gas O₂ and hydrogen gas O₂ does not occur. The distance between the plates is, preferably, about 0.25 inches, ranging from 0.2 to 0.3 inches. The combination of these variables provide a delicate balance among the values of electrolyte concentration, electric current, voltage, magnetic field, and electrode spacing so that dioxytetrahydride is produced and electrolysis of the water into hydrogen gas and oxygen gas does not occur.

There is a relationship between the concentration of electrochemical solution and the amperage which exists in the electrochemical solution upon application of current. The higher the specific gravity, the greater the amperage will be. This will also affect the strength of the magnetic field and increase the temperature of the solution. Electrolysis (used industrially to produce hydrogen gas via the reaction 2H₂O (l)->2H₂ (g)+O₂ (g)), which is not desired in the method disclosed herein, could occur if the current is too high or the electrode spacing is too small. The current may be too high if the specific gravity of the electrochemical solution exceeds the equivalent of 1.3 for potassium hydroxide.

In order for the magnetic field to be applied to the reaction zone, a power source (DC voltage) is applied respectively to the iron plates. This electromagnetic field inside the reaction zone transfers electrons through the electrochemical solution to associate with four hydrogens of two water molecules and causes a diatomic bond to form between the two oxygens of the two water molecules, thereby forming the water-gas. The additional electrons of the water-gas molecules repel other water-gas molecules to create a single stable water gas (dioxytetrahydride, H₄O₂).

Dioxytetrahydride is generated not only at the iron plates but also appears as bubbles in the body of the electrochemical solution. Dioxytetrahydride is produced in the body of electrochemical solution without the production of high levels of heat that would cause the water to vaporize (212° F.). Rather, the reaction zone remains at a temperature not exceeding 120° F. dependent on ambient temperature. Normally, there is a 30° F. temperature rise above ambient temperature, assuming room temperature 90° F. In other words, conditions in the reaction zone are such that the temperature remains less than about 10° F. below phase transition temperature. The collection chambers during the formation of dioxytetrahydride contain no detectable oxygen gas, no detectable hydrogen gas, no detectable hydrogen peroxide (a by-product of electrolysis) and no noticeable water vapor. Thus, production costs are lowered, production speed increases, compared to an electrolysis process, and the resulting dioxytetrahydride is uniform in its properties. Also important is that dioxytetrahydride can be pumped into a stainless-steel cylinder and has been found to be stable and not explosive under pressures of over 1000 psi.

The important functionalities in the process are imposition of a magnetic field on the electrochemical solution and flow of electrons through the electrochemical solution to generate dioxytetrahydride, under conditions short of those that will induce electrolysis. Over time in the operating reaction zone, only water is used to replenish the electrochemical solution and maintain the optimum specific gravity. In other words, only water is consumed in this process.

When water is converted into dioxytetrahydride, the natural conversion from liquid to gas creates an increase in volume (1:1, 800 increase) and thus an increase in pressure within the reaction zone. While standard atmospheric pressure is about 14.7 psi at sea level, the pressure in the closed reaction zone is maintained between one and 100 psi by using, preferably, a pressure regulator at the outlet of the reaction chamber to control it, since maximum gas production occurs in this pressure range.

Now referring to FIG. 1, a schematic of a reaction chamber is illustrated. Iron plates (1) and (2) are in opposing configuration, approximately 0.25 inches inch apart. A current is passed through an electrochemical solution (3) and the current flow through the electrochemical solution creates a magnetic field. This produces the single gas at a very efficient rate in the area of the reaction zone, as denoted by (4) in FIG. 1. The dioxytetrahydride produced may be collected from the reaction zone (4) through gas outlet (5) and subjected to further purification as taught herein.

Dioxytetrahydride is then, preferably, exposed to a second magnetic field by providing a second reaction zone comprising rare earth magnets. The strength of the rare earth magnets should be greater than fifty (50) Gauss units. Dioxytetrahydride flows through a chamber exposed to the rare earth magnets for removing any water vapor that might be mixed with dioxytetrahydride. Rare earth magnets, dense metal magnets typically made from a composite of neodymium, iron and boron with or without a nickel coating or plating, are attached to the exterior of the chamber. Since dioxytetrahydride is paramagnetic and water vapor is diamagnetic the magnetic chamber strengthens the molecular bond of dioxytetrahydride and repels the water vapor back into the either the electrochemical solution or is captured in a dryer.

Purified dioxytetrahydride is collected and may be used immediately or compressed and stored in a gas storage tank. The dioxytetrahydride may be allowed to flow out of the second reaction zone directly to a torch attachment, to a compressor for storage in a pressurized vessel, or gas outflow valve for infusion into water or other substances. Dioxytetrahydride is compressible and can be safely compressed above 1,000 psi and stored in a pressurized vessel indefinitely.

In an exemplary procedure for compression, dioxytetrahydride is discharged from the apparatus into a hose with a compressor attached. A Whirlwind Compressor, Model 2200-2 HPE, manufactured by High Pressure Eng. Co., Inc. (an oil-less compressor) can be used. A canister with pressure gauges is used to fill the chamber with the dioxytetrahydride, using a hose to transport dioxytetrahydride from the apparatus and compressor into the canister. An empty oxygen tank that has been vacuumed to remove any residual oxygen and water, may be used. The empty and vacuumed oxygen tank with a pressure valve has a manufacturer name of White Martins, ABRE with dimensions of 23″ diameter and 19″ height. Dioxytetrahydride can be placed under pressure in the compression chamber up to and beyond 1,000 psi, for example 3,000 psi, for storage of dioxytetrahydride. To test the stability of dioxytetrahydride, wood chips were placed in a stainless-steel tank and the tank filled with dioxytetrahydride. The wood chips absorbed the dioxytetrahydride and additional dioxytetrahydride was used to refill the chamber and maintain a pressure of 30 psi. Once the wood chips were saturated with dioxytetrahydride, the tank was decompressed, and pressure reduced to 0 psi. For a period of over 30 days, no pressure was generated showing that no out-gassing of dioxytetrahydride from the wood chips occurred. The wood chips displayed different burn properties after 60 days when compared to that of the non-treated wood chips. The treated wood chips with absorbed dioxytetrahydride burned more efficiently when compared to that of non-treated wood chips thereby demonstrating the stability of dioxytetrahydride to bond with the treated wood chips.

### Analytical Testing and Observations of Dioxytetrahydride Under Pressure

Maximum Pressure: dioxytetrahydride does not implode even when pressures exceed 1,600 psi. Instead, dioxytetrahydride requires a reaction such as a spark, for example, generated by a fitting failure of a high-pressurized chamber or exposure to a flame to cause the gas to implode.

Safe Pressurization: Dioxytetrahydride remains safe and stable at pressures around 1,000 psi for over 30 days. Dioxytetrahydride is expected to remain stable under pressure indefinitely, at least for a sufficient period of time to allow dioxytetrahydride to be utilized 30-60 days after generation.

Dioxytetrahydride was tested and exhibited properties of a pure, homogeneous gas that was found to be compressible as stated above, safe, and able to oxidize any non-oxidized substrate its flame contacted and, it was able to reduce any completely oxidized substrate its flame contacted.

The following characteristics were observed.

Ultra-violet Light Test: Dioxytetrahydride exhibits a blue gray color appearance compared to untreated distilled water which exhibits no color, when exposed to an ultra-violet light manufactured by Zelco Industries Model 10015.

Balloon: Dioxytetrahydride is lighter than air and causes balloons filled therewith to rise.

Cooling: In a balloon filled with dioxytetrahydride: the balloon remains inflated at or below −10° F.

Ignition: Dioxytetrahydride was tested for ignition properties. The dioxytetrahydride, when lit with an ignition source such as a spark, causes an implosion. The temperature of the flame produced upon ignition was estimated to be about 270° F., ranging from 216° F. to 324° F. using an infrared temperature device (Raynger ST2L infrared temperature device). However, when materials are exposed to the flame, which creates a chemical reaction with the material, base metals will rapidly rise to melt temperature points, releasing heat and converting the gas back into water (H₂O).

Dioxytetrahydride was discharged from the reaction zone through a hose with a torch attached. On the gas output of the apparatus, a flash-back arrestor is recommended. Dioxytetrahydride may be exposed to an ignition source (e.g., spark or electrical arc) and combustion of the gas occurs. The heat of the resulting flame on the subject torch has a temperature of approximately 270° F.

When an air/propane torch is burning, a small amount of dioxytetrahydride gas may be introduced into the air mixing chamber of the torch, whereby a single uniform flame cone becomes visible demonstrating a more efficient conversion of hydrocarbon and more heat from combustion of hydrocarbon due to the presence of dioxytetrahydride. This result indicates that dioxytetrahydride is useful as a fuel extender. One use of dioxytetrahydride is injection of dioxytetrahydride into an air intake of a combustion engine thereby reducing harmful exhaust emissions and increasing fuel efficiency. A by-product of this process is the creation of water during the combustion cycle in the form of steam. The steam causes an increase in torque generated by the combustion engine resulting in greater power output. Dioxytetrahydride extends fuel efficiency. When burning dioxytetrahydride contacts another substance, melting occurs within a short period of time, usually less than one minute. The results of some examples of substances exposed to ignited and burning dioxytetrahydride are found in Table 1 below.

In lieu of melting a substrate, ignited burning dioxytetrahydride may be applied to a substrate with a view toward capturing the generated heat as a useful product. The heat generated can be transferred to a substance such as air or water, thereby producing hot air or steam that can then be used industrially, such as for example to drive a turbine or piston-type engine for production of mechanical energy. In a preferred method, the flame of dioxytetrahydride can be applied to a substrate in conduit form having an inside surface and an outside surface. A substance such as forced air or water can flow thorough the conduit adjacent the inside surface of the conduit. The flame of dioxytetrahydride can be applied to the outside surface of the conduit which causes a heat generating reaction to occur. The heat is then transferred to the substance flowing through the conduit, preventing melting of the surface but creating a useful heated fluid that can be used in further applications. An exemplary conduit is a metal tube or pipe, such as copper tubing. It has been further determined that dioxytetrahydride can be infused into other substances, rendering a useful product.

TABLE 1
Effect of Ignited dioxytetrahydride on Various Substances

| | | Effect on Exposure to |
|---|---|---|
| | | Ignited Purified Gas |
| Substance | Melting Point | (one minute or less) |
| Stainless Steel | 2,600° F. | Melting. |
| Steel | 1,330° F. | Melting. |
| Copper | 1,984° F. | Melting. |
| Ceramic | 10,000° and 17,000° F. | Melting. |
| Tar Sands | | Sand converted to |
| | | glass and metals were |
| | | separated out of the |
| | | sand matrix. |
| Concrete | | Created a glassy |
| | | molten surface which |
| | | can adhere to metal |
| | | when cooled. |
| Glass | | Melts. Flame and |
| | | true colors are |
| | | achieved with no |
| | | carbon flakes or |
| | | residue embedded |
| | | inside the glass. |

Candles: Dioxytetrahydride infused into melted paraffin wax and poured into a mold with a wick will create candles that burn with lower carbon emission as observed using a Pace 400 Four Gas Analyzer.

Fluids: Dioxytetrahydride has an affinity for water and other liquids including fuels but they bubbled from the liquids after reaching a saturation point. One novel use of dioxytetrahydride is infusing it back into water to create ionized or polarized water. The resulting dioxytetrahydride-infused water creates smaller water clusters that are believed to permit faster cellular absorption and hydration.

In an exemplary method for infusing dioxytetrahydride into water, dioxytetrahydride is discharged from the reaction zone into a hose with a ceramic diffuser attached. For treating large volumes of water, a ceramic block diffuser may be used. The diffusers are used to reduce the size of the gas bubbles to improve efficiency of water absorption. Dioxytetrahydride may also be stored under pressure, and then infused into water.

It is preferred to infuse water that has gone through a distillation process prior to infusion of dioxytetrahydride into treated water with less than 1 ppm TDS (Total Dissolved Solids). One may use an absorption graph to determine time required for achieving desired absorption of gas into water. The typical rate of 30% absorption is approximately one hour to treat 100 gallons of water. A higher saturation of gas up to 100% of total absorption occurs with more infusion of gas into water over time. The actual time and percentage of absorption of gas are affected by the purity of water, volume of water, size of gas bubbles, temperature and other factors.

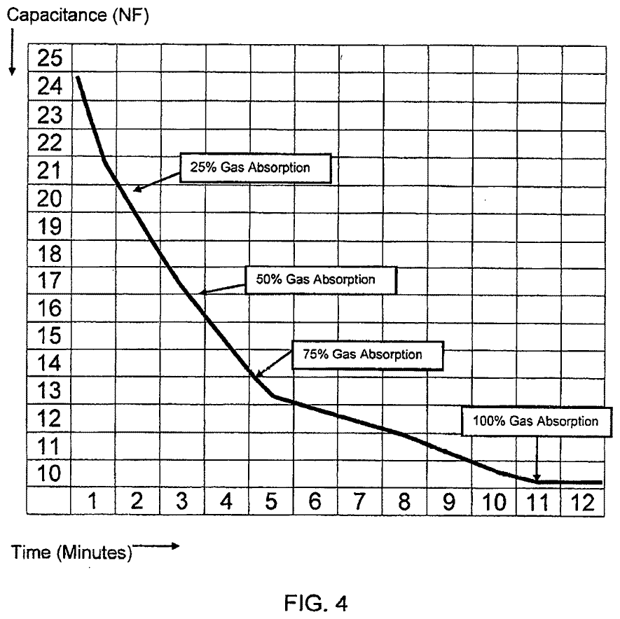

The resulting ionized or polarized water (“dioxytetrahydride-infused Water”) clings longer to a magnet when compared to that of regular water. Absorption over time or saturation graphs to monitor changes in the water properties infused with dioxytetrahydride including capacitance levels may be prepared. FIG. 4 shows a typical absorption over time graph for infusion of dioxytetrahydride into water. Subsequently, one may measure capacitance levels in the treated water over a time period exceeding 30 days to demonstrate that dioxytetrahydride in water is stable.

Other measurement: Total Dissolved Solids (TDS) dropped from a start of 0.33 ppm in untreated distilled water to a finish of 0.17 ppm after infusion of dioxytetrahydride into distilled water for a period of approximately 11 minutes. A Fluke 189 True RMS Multimeter was used to measure drop in capacitance.

Storage of dioxytetrahydride in Water: The resulting polarized water with dioxytetrahydride treatment remains stable and can be stored for 2 years or more. The actual maximum storage time has yet to be observed but in theory, dioxytetrahydride should remain permanently stable in the water.

Absorption: During infusion of dioxytetrahydride into purified water, a Fluke 189 True RMS Multimeter was used to measure drop in capacitance. The absorption over time graph is plotted to monitor the drop in capacitance. The first capacitance drop during initial infusion of the dioxytetrahydride into a gallon of purified water occurs within the first three minutes of infusion. After that time, the capacitance gradually drops until the point of maximum saturation of dioxytetrahydride is typically reached between eight and 20 minutes depending on variables including initial purity of water, size of gas bubbles, and volume of water to be treated. The resulting treated or infused water is referred herein as gas-infused Water.

Other Parameters Monitored: During infusion of dioxytetrahydride into purified water, a drop in TDS (Total Dissolved Solids) concentration, conductivity and resistively can be measured. An appropriate measuring device is a Control Company Traceable™ #4063CC meter. pH Test: Lab tests show that distilled water had a pH of 6.8 and when infused with dioxytetrahydride had a pH change to 7.6.

Ice Cubes: Dioxytetrahydride remains in gas-infused water or polarized water until freezing temperatures when dioxytetrahydride forms a gas bubble within the ice cube itself, sometimes producing on the surface of the ice cubes, capillary tubes where dioxytetrahydride escapes.

Ultraviolet Light Exposure: Gas-infused water was tested for the effects of ultraviolet light exposure. A clear spray bottle containing gas-infused water or polarized water placed in the Florida sun for over two years remained clear in appearance and without algae growth which had been observed in water not infused with dioxytetrahydride under similar conditions.

Magnets: A drop of gas-infused water clings to the surface of a magnet longer when compared to that of untreated water.

Many uses have been found for gas-infused Water. Table 2 lists some of those uses. Dioxytetrahydride herein is disclosed to be an ionized H₄O₂ gas with the potential to oxidize or reduce any substance. On a non-oxidized substrate, such as steel, the active oxygen atom within the dioxytetrahydride molecule will chemically bond to the steel bringing it immediately to its melting temperature and releasing hydrogen, which bonds with atmospheric nitrogen to produce heat. On an oxidized substrate, such as ceramic, the hydrogen atom reduces the substrate by chemically bonding with the oxygen present within the substrate, melting the material and releasing oxygen atoms, which then bond with the material. This double reaction is responsible for producing much more heat than an ordinary oxidation reduction reaction.

TABLE 2
USES FOR DIOXYTETRAHYDRIDE GAS INFUSED WATER

| | Advantages Provided Over |
|---|---|
| Use | Untreated Water |
| Drinking water for human and | Efficient cellular absorption and |
| animal consumption and hydration | removal of toxins. |
| Water for food and health supplement | Pure form of water that improves |
| manufacturing, preparation, and | product quality, shelf life, nutrient |
| cooking | benefits, absorption, and taste. |
| Water for cleaning and enhancing | Reduced need for emulsifiers and |
| effectiveness of cleansers | surfactants. |
| Water for plants and crops including | Greater size of plants, improved |
| hydroponics, floral arrangements and | plant quality, longer viability, |
| turf (golf courses) | and reduced scale buildup |
| | including in hydroponic water |
| | containers. |
| Fertilizer solution for application on | Higher yield and more vigorous |
| plants and crops | growth. |
| Water for aquariums and fish farming | Greater size of fish. |
| Water systems including long-term | Less algae growth resulting from |
| water storage, municipal supplies and | antibacterial properties. |
| in-home treatment systems | |
| Steam, air heating and air | Less algae or mold growth for |
| conditioning systems | cleaner air circulation systems. |
| Refrigeration systems | Less mold accumulation. |
| Industrial scrubbers | Less algae growth and scale |
| | buildup to maintain scrubbing |
| | efficiency. |
| Industrial products and processes | Reduce or eliminate need to use |
| including oil, gas and tar sand | petroleum-based solvents. |
| extraction | |
| Pharmaceutical and medicine | Efficient carrier of medicines and |
| manufacturing | removal of by-products from |
| | medicines and solvent carriers. |
| Skin treatment products | Hydration of skin cells, improved |
| | absorption of moisturizers, and |
| | reduction in pigment changes due |
| | to sun damage. |
| Wound treatment products | Faster healing and pain relief. |
| Respiratory relief used in humidifier | Improved breathing with less |
| systems | snoring. |
| Eye relief products | Relief for irritated eyes and |
| | hydration. |
| Dental care products | Removal or inhibit plaque and |
| | stains on teeth. |
| Cosmetics and beauty supplies | Less need for chemical binders and |
| | more resistant to contamination |
| | buildup in cosmetics; improved |
| | hair growth. |
| Water features including swimming | Cleaner water with less or no |
| pools, spas, hot tubs, waterfalls, | chlorine and chemical additives. |
| fountains, water amusement parks | |

These reactions are proven on rusty steel and concrete. When ordinary gas, such as: methane, ethane, propane, butane, or acetylene are applied to rusty steel, popping and spitting of material occurs due to the explosive reaction of the ferrous oxide being separated from the non-oxidized metal due to different expansion rates.

With dioxytetrahydride, this does not occur, since oxidation and reduction are occurring at the same time and the expansion rates are equal. On concrete when heat from an ordinary gas is applied, the portion of the concrete that the flame of the gas touches will expand and break loose from the rest of the concrete with an explosive force and spit pieces of hot concrete outward and leave holes in the concrete surface. Again, this does not occur with the flame of dioxytetrahydride because dioxytetrahydride is being reduced to a liquid form before the pressure of uneven expansion occurs.

Simply stated dioxytetrahydride is an ionized H₄O₂ gas capable of oxidizing or reducing almost any material without the adverse reactions created by heat producing flames. Heat is the byproduct of friction, in chemistry two atoms colliding together in a reaction known as oxidation and reduction cause this friction. A gas, referred to as a fuel, is usually a hydrocarbon that is easily oxidized; however, the carbon is what is being oxidized and the oxygen is being reduced meaning this is where friction occurs and these are the items being heated. Heat given off by these substances is refractive heat and the substances being heated are absorbing heat or, better stated, are being bombarded by fast moving hot gases. Dioxytetrahydride may change the definition of melting point due to the lack of heat producing flames.

Use of Dioxytetrahydride in Tar Sands Extraction: Conventional water with petroleum solvents used in the separation of tar from sand was replaced with dioxytetrahydride gas-infused water. Gas-infused water was heated (no petroleum solvent added) with a sample of tar sands in a pan to approximately 160° F. Tar was observed separating from the sand, providing a cleaner and more efficient process with less by-products and emissions released from tar extraction.

Use of Dioxytetrahydride for Improved Cleaning: For laundry, one may add a quantity (⅓ of a gallon in a standard washing machine tub of 12 gallons for medium load and 16 gallons for large load) of gas-infused water to the soap cycle of a top loading washing machine and the remaining water (approximately ⅔ of a gallon) is added to the rinse cycle. The polarized characteristic and smaller molecular size of gas-infused water enables the detergent and water solution to more thoroughly penetrate the cloth fabric and remove the dirt and grime. The addition of gas-infused water to the rinse assists in completely removing the soap residue that may contain residual dirt from the fabric. This process results in cleaner and stain-free laundry with less body oil and bacteria buildup. Laundry without these gas-infused water additives display less brilliant whites and retain a pungent odor caused by residual bacteria living in the fabric of the washed clothes.

Reduced Use of Emulsifiers and Surfactants: One may dilute cleaning solutions with gas-infused water for effective cleaning of surfaces to remove grime, oil and grease and removal of bacteria. Gas-infused water is a natural disinfectant without harsh chemical additives. Typically, one uses at least 1 part cleaning solution with 20 parts gas-infused water to maintain cleaning properties.

### Biological Properties

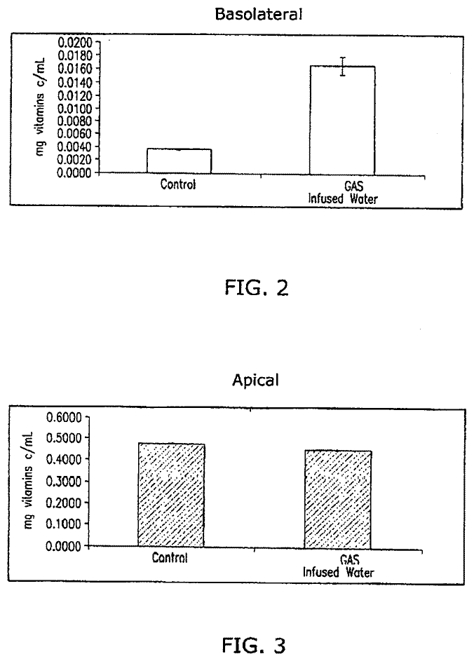

Transport, Delivery and Absorption of Nutrients: In a controlled experiment, a standard drug metabolism test in vitro was conducted over a period of 21 days. This comparative test was performed on cell membrane permeability for Vitamin C solution (L-ascorbic acid) using (1) Hank's Buffered Saline Solution (HBSS) and (2) gas-infused water. Caco-2 cells were used and permeability of the apical side (similar to intestine surface) and basolateral side (similar to underneath intestinal surface) for the separate solutions were determined. Vitamin C quantification was conducted on HPLC (HP1100 equipped with PDA detector) and Zorbax C18 reverse phase column 30 (4.6×250 mm, 5 micro) at 30 C. Test results demonstrated Vitamin C permeability of gas-infused water was about 4 times higher than the control counterpart. (Hu, 2008 (unpublished communication). Results are provided in FIGS. 2 and 3.

Plant Growth: In a controlled greenhouse setting, four groups of ivy plants were watered using (1) 100% well water, (2) mix of ⅓ mix gas-infused water and ⅔ well water, (3) mix of ⅔ gas-infused water and ⅓ well water, and (4) 100% gas-infused water. The ivy plants were harvested and dehydrated to allow measurement of dry plant mass. The fourth group of 100% gas-infused water had over 16 percent increase in mass when compared to that of the first group of well water. (Reiser, 2006 (private communication).

Fish Growth: Two home aquariums were used to hold two respective groups of goldfish. Dioxytetrahydride was bubbled into one aquarium and the second with air for a period of thirty days. It was observed that the goldfish in the former aquarium aerated by gas grew at least 15 percent more and the aquarium tank remained cleaner with less algae growth.

Wound Treatment and Healing: The polarization of the gas-infused water provides natural anti-bacterial and non-toxic anti-infective properties that promote healing of superficial and multi-layer wounds and a reduction in pain perception. A fifty-year old woman burned herself by accidentally spilling scalding-hot coffee onto her hand. Upon seeking medical attention, a physician advised the patient that she may have to undergo debridement or dead skin removal and possible skin graft surgery. The patient washed the affected area with gas-infused, purified water and applied a medicinal ointment. The wound was wrapped with a sterile gauze and the gauze was moistened to keep the wound hydrated with gas-infused water. The patient reported an immediate and on-going lessening of pain with the application of gas-infused water. Over the period of ten days with repeating these treatment steps involving changing of the moistened sterile gauze on at least a daily basis, the site of the wound developed new skin with minimal evidence of scarring.

Upon cessation of the treatment regime when the upper skin layer appeared to be healed, blisters appeared on the surface of the skin. The treatment with gas-infused water was reinitiated and the blisters healed as well as the remaining layers of skin. The patient experienced healing and thereby avoided debridement of dead skin, and skin grafts.

Skin Treatment: Topical applications twice a day on each side of a male volunteer's face in vicinity of his eyes were made. Two types of topical solutions were prepared with 1% magnesium ascorbyl phosphate (MAP), one using gas-infused water and the other using tap water. After 21 days, the volunteer observed on the side where gas-infused water solution was applied, a slight reduction in the depth of fine lines around the eye and a lighting of darker skin pigment when compared to that of the other area where the tap water solution was applied. (Puleo of Optima Specialty Chemical, 2008 (private communication).

Eye Relief: Gas-infused water may be sprayed into the eyes for immediate relief and lessening of redness that is comparable to use of over-the-counter eye drops. This natural treatment, without any chemical additives, assists in hydrating eyes and removing irritants such as dust and pollen.

Dental Care: A 50:50 solution of commercial mouth wash was mixed with gas-infused water, and a capful of this solution was used twice a day after brushing teeth. Less plaque buildup and stains were noted by professional dental hygienists as compared to previous observations six months earlier when this solution had not been used.

### Molecular Structure Based on Gas Properties

It is believed by the inventors from observing the properties of dioxytetrahydride that the process disclosed herein results in a product not achieved by heretofore-reported processes for the conversion of water into a gas form H₄O₂.

Given the low energy reaction that created the gas form, and the use of no catalysts, it is believed unlikely that any O—H bonds of water could possibly be broken in the process used. It is known that breaking O—H bonds requires two faradays per mole and the process of the invention only employs 2.8 watt hours per liter, which is about a maximum of 1.6 faradays per mole. Further, the dioxytetrahydride gas resulting from the process disclosed herein is flammable, but the flame temperature of the gas is only about 270° F. (132.2° C.), as compared to diatomic hydrogen gas which is highly combustible and auto ignites at 560° C. A hydrogen/oxygen torch flame is reportedly 3200° C.=5792° F. However, the dioxytetrahydride flame easily melts metals, which likely indicates that an oxygen is active. The dioxytetrahydride flame also reduces ceramics, which indicates that the hydrogen is in an ionized state.

Dioxytetrahydride has an affinity for water and other liquids including fuels, but bubbles from the liquids after reaching a saturation point. One use of the dioxytetrahydride disclosed herein is infusing it back into water to create ionized or polarized water.

Dioxytetrahydride is always a gas at room temperature while normal water vapor requires energy to evaporate in great quantities. When combusted, dioxytetrahydride always returns to liquid water. When placed in a balloon, the gas initially floats the balloon, but it seeps from the balloon rather quickly indicating that the gas has a small molecular structure.

Dioxytetrahydride is an electron-rich gaseous form of water not created by electrolysis, but rather by creating an electron rich environment with a targeted, energy efficient process that provides a reaction zone for dioxytetrahydride to form. Dioxytetrahydride is created when very strong, targeted electromagnetic fields are applied to liquid water in the presence of an electrochemical solution. The electromagnetic energy provided is sufficient to promote formation of diatomic oxygen from two water molecules. The arrangement of the remaining hydrogen from the same water molecules is also impacted by the process. These same excess electrons provide the targeted energy to overcome the normal H—O—H water geometry and allow a larger, yet stable arrangement of hydrogen and oxygen to form, (ie: H₄O₂). The same electron rich environment promotes a hydride character of the hydrogen portion of this new structure and allows its bond angle to be altered between the hydrogen and oxygen, (from 104° to 118°). In addition, the same hydride character of hydrogen portion of this new arrangement provides the stability for its new geometry, inhibits “proton like” clustering, and helps maintain a stable, autonomous, independent H₄O₂ liquid-gas structure.

In generating dioxytetrahydride, there are no appreciable hydrogen Cations (H+) or Anions (H−) formed in the completed reaction. However, the provision of an electron rich environment promotes the hydride behavior in the hydrogen portion of the (H₄O₂) structure. It is this hydride effect that prevents conventional ionization and inhibits the gas molecules from clustering like the H+ proton. In other words, the electrons repel other available water molecules and this in turn, allows enough stability for the (H₄O₂) to form, (not cluster), and exist in an autonomous, stable, water gas, (H₄O₂), independent molecular structure. It is the addition and surplus of electrons that repel water molecules to create the gas of this invention and not the breaking of either hydrogen or oxygen bonds like that which occurs in classic electrolysis. This absence of bond breaking explains how such a low amount of energy is used to convert liquid water into dioxytetrahydride with this process.

The inventors have discovered a new isomer of water. The oxygen is active and can oxidize metals. In the unburned gaseous state, the increased negative charge causes greater spacing among the gas molecules causing stability, a lower boiling point, a lower freezing point, and a higher vapor pressure. The gas does not cluster to create liquid water at regular atmospheric temperatures and pressures as does the molecules of normal water vapor. The gas exists in a higher energy state, burns by itself at a low temperature, and melts any substrates when exposed to the gas flame. The gas flame has a uniform blue color appearance without yellow sparks indicative of water (H₂O) vapor, or red sparks, indicative of either H₂ or O₂ gas contamination.

Overall, the method herein employs creation of a magnetic field in which two oxygens are forced into a diatomic bond with four hydrogens (H₄O₂). Under these conditions two water molecules bind in a stable gaseous state. The temperature in the receptacle remains less than 30° F. above ambient temperature. Under these conditions, a single gas, dioxytetrahydride, having the molecular composition of water is generated and collected. Dioxytetrahydride appears to be an isomer of water.

### Gas Discharge Visualization (GDV) and the Kirlian Effect

Currently, the term Kirlian effect is used to describe the visual observation and digital photographic capturing of a biological subject. A glow or “energy field” surrounds the object's surface when it is placed in a charged electrical field and photographed using a gas discharge emission. The results of capturing these biological subjects is known as “bioelectrography” or electrophotonics, as well as Kirlian photography. The analysis of infused water from the inventive process was undertaken by Dr. Zachary Bush, M.D. with peer review by Mary Milroy—CEO, GDV Source, BSIE, Dipl. Esogetic Medicine, Dipl. Ac & CH (NCCAOM).

In using a GVD (Gas Discharge Visualization) Camera, droplets of many types of water, including the gas-infused water of this invention, were suspended and energy measurements were taken. One type of water tested was water infused with Brown's gas or gas produced from electrolysis (named “Sparks”). The test results for the gas-infused water were significantly novel from those of other types of water tested, with a sixteen standard deviation difference of the gas-infused water from the other types of water tested including “Sparks” water. Again using the GVD camera and the same testing protocol, gas-infused water produced over seven years before this testing had similar results. These results of the gas-infused water show a very high level of energetic activity and stability.

One of the theories on the gas-infused water with its H₄O₂ (double water molecule) structure enriched with electrons is that it is more compatible with that of humans, animals and plants when compared with a H—O—H (single water molecule) structure. Electrons associated with hydrogen are used in the Krebs Cycle to allow cellular mitochondria to produce energy for the body. The remaining oxygen is more benevolent to the body if left in a diatomic (O₂) state as opposed to a single nascent oxygen (O) which can contribute to oxidative stress that in turn, can lead to malignant tumors and other diseases of the body.

In the process used herein, electrolysis does not take place. “Electrolysis” is defined as a “method of separating chemically bonded elements and compounds by passing an electric current through them.” Electrolysis does not take place in the method disclosed herein and no splitting of the water molecular bonds occurs, as is demonstrated by the fact that no increase in hydrogen or oxygen gas can be detected in the reaction zone. This is a key differentiator from the processes that have resulted in a gas being produced by electrolysis of water. The gases produced by electrolysis exhibit far different properties from the gas discovered herein. Gases produced by electrolysis are explosive, cannot be pressurized and are heat-producing gases on ignition. One method to prove no electrolysis is to test Oxidation Reduction Potential (ORP) of pure water infused or saturated with gas in it. ORP was tested by a nationally recognized lab before and after “sparging” with nitrogen gas. Duplicate nitrogen sparge tests were performed on duplicate samples from the same aliquot of above said inventive gas saturated solution. Before ORP's were measured at 379 mV (millivolts) and 380 mV respectively. After ten-minute continuous sparge with nitrogen gas, the ORPs were measured at 345 mV and 342 mV respectively. The 9 to 10% drop in ORP was explained from the effect of the plastic sparger tube surface immersed in and connected to the fish tank stone sparger consuming some of the ORP. The conclusion: if Gas was ionized hydrogen and/or oxygen (by-products of electrolysis), then the amounts of these ions would have been measured much higher in solution before sparging, and the ORP would have changed notably as soon as the nitrogen gas was allowed to sparge into the inventive gas saturated solution.

Producing Hydrogen Gas from Dioxytetrahydride Gas Using Renewable Energy Sources

The dioxytetrahydride gas generated by this method can be passed through a molecular sieve to obtain hydrogen gas (H₂). The system described above that produces dioxytetrahydride gas creates a significant gas pressure in the receptacle such that the pressure enables the dioxytetrahydride gas to flow through a molecular sieve (or any other separation filter). No external power is needed for the physical separation of dioxytetrahydride gas into hydrogen molecules and oxygen molecules. It was discovered, surprisingly, that hydrogen atoms of the dioxytetrahydride gas pass through the micropores in the sieve to the exterior of the sieve and combine to form hydrogen gas (H₂). At the same time, oxygen atoms from the dioxytetrahydride gas combine to form oxygen gas (O₂) in the interior of the sieve. 0.0028 kWh of the DC electric current will produce 0.8-1.3 liters of dioxytetrahydride gas which yields at least 0.08-0.13 liters of hydrogen gas when passed through the molecular sieve.

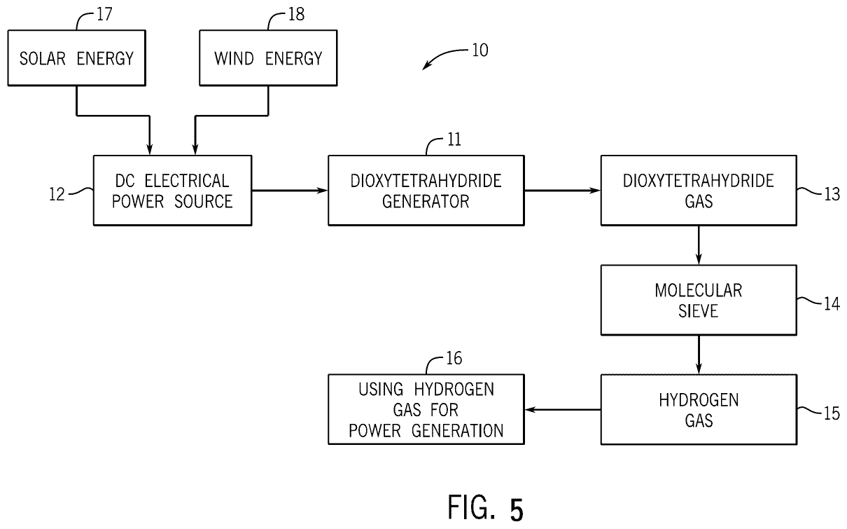

FIG. 5 shows a diagram of a system 10 to produce dioxytetrahydride gas 13 and to generate hydrogen (H₂) 15 from the dioxytetrahydride gas 13. A DC electrical power source 12 is connected to a dioxytetrahydride generator 11. DC electrical current passes through the aqueous electrochemical solution in the dioxytetrahydride generator 11 and dioxytetrahydride gas 13 is generated, as described above. The dioxytetrahydride gas 13 is passed through a molecular sieve 14 using the pressure generated by the formation of the dioxytetrahydride gas 13 in the dioxytetrahydride generator 11. The molecular sieve 14 separates the hydrogen atoms from the oxygen atoms in the dioxytetrahydride gas 13 by methods well known in the art. Hydrogen atoms passing through the molecular sieve to the exterior of the molecular sieve combine to form the hydrogen gas (H₂). The hydrogen gas can be collected and stored by methods known in the art.

Generally, the hydrogen gas (H₂) can be produced by:
1) preparing dioxytetrahydride gas by producing a reaction media comprising an aqueous electrochemical solution comprising one or more alkaline salts;
2) placing the reaction media into a receptacle of an apparatus having a power supply and producing a magnetic field in a reaction zone via a direct electric current;
3) collecting the dioxytetrahydride gas formed in the reaction zone after exposure to the magnetic field;
4) infusing the collected dioxytetrahydride gas into a molecular sieve;
5) separating hydrogen atoms from oxygen atoms in the molecular sieve;
6) forming hydrogen gas from the hydrogen atoms; and
6) collecting hydrogen gas from the molecular sieve.

The hydrogen gas (H₂) can be produced more specifically by:
1) preparing dioxytetrahydride gas by providing an electrolyte and water solution capable of conducting an electric current wherein the electrolyte and water solution has a specific gravity ranging from 1.0 to 3.0;
2) placing the electrolyte and water solution in a receptacle;
3) providing an anode and a cathode formed of material capable of being magnetized, spaced 0.2 to 0.3 inches apart and in contact with the electrolyte and water solution;
4) providing a direct electrical current to the anode and to the cathode and to the electrolyte and water solution at 1.2 to 1.8 volts at 0.2 to 0.3 amps per square inch of cathode surface area in the presence of a magnetic field ranging from 16 to 24 Gauss units, wherein the magnetic field generates dioxytetrahydride gas from the water in the electrolyte and water solution;
5) collecting the dioxytetrahydride gas generated from the water in the electrolyte and water solution;
6) passing the collected dioxytetrahydride gas through a molecular sieve;
7) separating hydrogen atoms from oxygen atoms in the dioxytetrahydride gas in the molecular sieve, wherein the hydrogen atoms that pass through the molecular sieve combine to form molecular hydrogen gas (H₂); and
8) collecting the molecular hydrogen gas (H₂) from the molecular sieve.

A preferred molecular sieve is a ceramic membrane substrate. The most common type of molecular sieve used for hydrogen purification is a 5A molecular sieve (Research Catalysts Inc. (hyfindr.com/en/shop/products/rci-dri-molecular-sieves-desiccants-for-hydrogen-dehydration). Preferred sources of clean power for the dioxytetrahydride generator 11 are solar energy 17 and wind energy 18. A dioxytetrahydride generator (WIT Machine) is commercially available from WIT International LLC (https://www.wateriontechnologies.com/) and produces dioxytetrahydride gas by the methods disclosed herein. The hydrogen generated from the system shown in FIG. 1 has additional energy compared to hydrogen generated by high-temperature steam or the capture of hydrogen from fossil fuels. Hydrogen gas generated by an electrolyzer device in a Horizon Solar Hydrogen Science Kit (Amazon.com) and passed through a reversible PM fuel cell in the kit produces 1 watt. If the hydrogen gas generated by the kit is replaced (substituted) with hydrogen gas generated from dioxytetrahydride gas, as described above, that hydrogen gas will produce 2 watts. The additional energy of 1 watt from the hydrogen gas produced from dioxytetrahydride gas, compared to the hydrogen gas from the kit, results from additional electrons in the magnetic field combining with hydrogen as dioxytetrahydride gas is being formed from the aqueous electrochemical solution.

The method of this disclosure makes the production of hydrogen commercially feasible. It takes 0.0028 kWh (Kilowatt hours) of DC electric current to produce 0.8-1.3 liters of dioxytetrahydride gas which yields 0.08-0.13 liter of hydrogen or 0.028 kWh for 0.08-1.3 liter of hydrogen. On the other hand, it takes 0.146 kWh of DC electric current to produce 1 liter of hydrogen by high-temperature steam or the capture of hydrogen from fossil fuels using an electrolyzer. Solar panels produce 0.17 to 0.35 kWh. Assuming using a 0.17 kWh solar panel, one solar panel will make 0.17/0.0028=60 liters of dioxytetrahydride gas which provides 6.6 liters of hydrogen. On the other hand, one solar panel will make 0.17/0.146=1.2 liters of hydrogen applying high-temperature steam or the capture of hydrogen from fossil fuels using an electrolyzer. Thus, solar and wind power generating systems are commercially feasible for producing hydrogen gas by the method of this disclosure whereas they are not commercially feasible for current methods of producing hydrogen gas. The method disclosed herein produces at least five times more hydrogen gas per unit of energy than produced by current methods of producing hydrogen gas.

The foregoing description illustrates and describes the system and method of the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular application or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above to explain the nature of this invention may be made by those skilled in the art without departing from the principle and scope of the invention as recited in the following claims.

What is claimed is:

1. A method of producing hydrogen gas (H₂) from dioxytetrahydride gas, comprising:
1) preparing dioxytetrahydride gas by providing an electrolyte and water solution capable of conducting an electric current wherein the electrolyte and water solution has a specific gravity ranging from 1.0 to 3.0;
2) placing the electrolyte and water solution in a receptacle;
3) providing an anode and a cathode formed of material capable of being magnetized, spaced 0.2 to 0.3 inches apart and in contact with the electrolyte and water solution;
4) providing a direct electrical current to the anode and to the cathode and to the electrolyte and water solution at 1.2 to 1.8 volts at 0.2 to 0.3 amps per square inch of cathode surface area in the presence of a magnetic field ranging from 16 to 24 Gauss units, wherein the magnetic field generates dioxytetrahydride gas from the water in the electrolyte and water solution;
5) collecting the dioxytetrahydride gas generated from the water in the electrolyte and water solution;
6) passing the collected dioxytetrahydride gas through a molecular sieve;
7) separating hydrogen atoms from oxygen atoms in the dioxytetrahydride gas in the molecular sieve, wherein the hydrogen atoms that pass through the molecular sieve combine to form molecular hydrogen gas (H₂); and
8) collecting the molecular hydrogen gas (H₂) from the molecular sieve.

2. The method of claim 1, further comprising infusing said collected dioxytetrahydride gas into the molecular sieve using pressure generated in the receptacle during formation of the dioxytetrahydride gas in the reaction zone.

3. The method of claim 1 wherein the molecular sieve is a ceramic membrane substrate.

4. The method of claim 1 wherein 0.0028 kWh of the DC electric current will produce 0.8-1.3 liters of dioxytetrahydride gas which yields at least 0.08-0.13 liter of hydrogen gas.

5. The method of claim 1, further comprising producing a magnetic field in the reaction zone via a DC electric current using a solar or wind electricity generator.

6. A method of producing hydrogen gas (H₂) from dioxytetrahydride gas, comprising:
1) preparing dioxytetrahydride gas by providing an electrolyte and water solution capable of conducting an electric current wherein the electrolyte and water solution has a specific gravity ranging from 1.0 to 3.0;
2) placing the electrolyte and water solution in a receptacle;
3) providing an anode and a cathode formed of material capable of being magnetized, spaced 0.2 to 0.3 inches apart and in contact with the electrolyte and water solution;
4) providing a direct electrical current to the anode and to the cathode and to the electrolyte and water solution at 1.2 to 1.8 volts at 0.2 to 0.3 amps per square inch of cathode surface area in the presence of a magnetic field ranging from 16 to 24 Gauss units, wherein the magnetic field generates dioxytetrahydride gas from the water in the electrolyte and water solution;
5) collecting the dioxytetrahydride gas generated from the water in the electrolyte and water solution;
6) passing the collected dioxytetrahydride gas through a molecular sieve, wherein the molecular sieve is a ceramic membrane substrate;
7) separating hydrogen atoms from oxygen atoms in the dioxytetrahydride gas in the molecular sieve, wherein the hydrogen atoms that pass through the molecular sieve combine to form molecular hydrogen gas (H₂), wherein pressure generated in the receptacle during formation of dioxytetrahydride is used to pass the collected dioxytetrahydride through the molecular sieve; and
8) collecting the molecular hydrogen gas (H₂) from the molecular sieve.

7. The method of claim wherein 0.0028 kWh of the DC electric current will produce 0.8-1.3 liters of dioxytetrahydride gas which yields at least 0.08-0.13 liter of hydrogen gas.

8. The method of claim 6, further comprising producing a magnetic field in the receptacle via a DC electric current using a solar or wind electricity generator.

9. A method of producing hydrogen gas (H₂) from dioxytetrahydride gas, comprising:
1) preparing dioxytetrahydride gas by providing an electrolyte and water solution capable of conducting an electric current wherein the electrolyte and water solution has a specific gravity ranging from 1.0 to 3.0;
2) placing the electrolyte and water solution in a receptacle;
3) providing an anode and a cathode formed of material capable of being magnetized, spaced 0.2 to 0.3 inches apart and in contact with the electrolyte and water solution;
4) providing a direct electrical current to the anode and to the cathode and to the electrolyte and water solution at 1.2 to 1.8 volts at 0.2 to 0.3 amps per square inch of cathode surface area in the presence of a magnetic field ranging from 16 to 24 Gauss units, wherein the magnetic field generates dioxytetrahydride gas from the water in the electrolyte and water solution;
5) collecting the dioxytetrahydride gas generated from the water in the electrolyte and water solution;
6) passing the collected dioxytetrahydride gas through a molecular sieve, wherein the molecular sieve is a ceramic membrane substrate;
7) separating hydrogen atoms from oxygen atoms in the dioxytetrahydride gas in the molecular sieve, wherein the hydrogen atoms that pass through the molecular sieve combine to form molecular hydrogen gas (H₂), wherein pressure generated in the receptacle during formation of dioxytetrahydride is used to pass the collected dioxytetrahydride through the molecular sieve;
8) collecting the molecular hydrogen gas (H₂) from the molecular sieve, wherein 0.0028 kWh of the DC electric current will produce 0.8-1.3 liters of dioxytetrahydride gas which yields at least 0.08-0.13 liter of hydrogen gas; and
9) producing a magnetic field in the receptacle via the direct electric current using a solar or wind electricity generator.
